(19) United States
(12) Patent Application Publication
(10) Pub. No.: US 2013/0214124 A1
(43) Pub. Date: Aug. 22, 2013

(54) LIGHT CURTAIN

(71) Applicant: Leuze electronic GmbH + Co. KG, (US)

(72) Inventors: Bernhard MUELLER, Herrenberg (DE); Armin Mueck, Pliezhausen (DE); Arnold Schoenleitner, Purkersdorf (AT); Robert Schedlberger, Bad Zell (AT)

(73) Assignee: Leuze electronic GmbH + Co. KG, Owen/Teck (DE)

(21) Appl. No.: 13/773,172

(22) Filed: Feb. 21, 2013

(30) Foreign Application Priority Data
Feb. 21, 2012 (DE) 102012101368.3

(51) Int. Cl. G01V 8/20

(52) U.S. Cl. CPC G01V 8/20
USPC 250/206.1

(57) ABSTRACT

The invention relates to a light curtain for detecting objects within a monitored region. The light curtain comprises an arrangement of transmitters that emit light rays, an arrangement of receivers for receiving the light rays, and an evaluation unit. Object detection signals are generated in the evaluation unit in dependence on the receiving signals present at the outputs of the receivers. The light curtain is divided into sub-regions containing a specified number of transmitters and receivers. The individual sub-regions can be adjusted individually through separate parameter settings. A separate evaluation is realized in the evaluation unit for the individual sub-regions.

### CROSS-REFERENCE TO RELATED APPLICATION

This application claims the priority of German Patent Application DE 10 2012 101 368.3, filed on Feb. 21, 2012, the subject matter of which is incorporated herein by reference.

### TECHNICAL FIELD

Embodiments of the present invention relate to a light curtain for detecting objects.

### BACKGROUND

Light curtains in general function to detect objects in a monitored region and may comprise a transmitting unit with an arrangement of transmitters that emit light rays and a receiving unit with an arrangement of receivers for receiving the light rays. The transmitting unit and the receiving unit are arranged on opposite edges of the monitored region, such that if the monitored region is clear, the light rays from a transmitter impinge on an associated receiver, positioned on the opposite side. This transmitter/receiver pair forms a beam axis for the light curtain. The individual beam axes of the light curtain are activated cyclically, one after another. For this, a control unit is integrated into the transmitting unit which actuates a shift register in such a way that the individual transmitters are activated cyclically, one after another. An evaluation unit is integrated into the receiving unit which actuates a different shift register, such that the individual receivers are also activated one after another, wherein the activation of the transmitters and the receivers is synchronized either optically or electronically. As a result of this synchronization, the individual transmitter/receiver pairs of the light curtain are activated cyclically, one after another.

In order to generate an object detection signal in the form of a binary switching signal, an evaluation of the receiving signal amplitude is realized in the evaluation unit with the aid of one or several threshold values. A test is conducted within one cycle, during which all transmitter/receiver pairs are successively activated, to determine whether the light rays of at least one beam axis are interrupted. If that is the case, the evaluation unit emits an object message for the switching signal state. If no beam axis is interrupted, the switching signal state indicates a clear monitored region.

One essential disadvantage of such light curtains is that the evaluation is restricted purely to detecting the presence of an object. More complex evaluations, in particular local resolution evaluations, are possible only to a limited degree.

### SUMMARY

It is an object of embodiments of the present invention to provide a light curtain of the aforementioned type which has a higher functionality with low design expenditure.

The above and other objects are accomplished according to embodiments of the present invention. Various embodiments and modifications of the invention are described herein.

According to an embodiment of the invention, there is provided a light curtain for detecting objects within a monitored region. The light curtain comprises an arrangement of transmitters that emit light rays, an arrangement of receivers for receiving the light rays, and an evaluation unit. In this evaluation unit, object detection signals are generated in dependence on the signals present at the outputs of the receivers. The light curtain is divided into sub-regions containing respectively a predetermined number of transmitters and receivers. The individual sub-regions can be individually adjusted with the aid of separate parameter settings. A separate evaluation is realized in the evaluation unit for the individual sub-regions.

According to another aspect of the present invention, there is provided a method for detecting an object within a monitored region with a light curtain, the light curtain having an arrangement of transmitters, an arrangement of receivers, and an evaluation unit, wherein the method comprises emitting light rays from the arrangement of transmitters, receiving the light rays with the arrangement of receivers, generating object detection signals in the evaluation unit in dependence on signals present at the outputs of the receivers, dividing the light curtain into sub-regions with respectively a predetermined number of transmitters and receivers, adjusting the sub-regions individually through separate parameter settings, and realizing a separate evaluation in the evaluation unit for each sub-region.

The individual sub-regions of the light curtain form individual, completely functional logical light curtain units which respectively make possible separate object detections. In contrast to several light curtains which are physically separate, the light curtain according to the present invention has a considerably simpler and more cost-effective design since only a single evaluation unit is needed for the individual logical light curtain units and additional sensor components and casing arrangements can also be utilized jointly.

According to an embodiment of the present invention, the individual sub-regions of the light curtain can be parameterized separately and thus also differently, so that the individual sub-regions can be adapted to different application requirements. The type of signal evaluation can also be embodied differently for the individual sub-regions and can thus be adapted to different application conditions.

The different sub-regions can be used to detect different object structures, respectively with a high degree of detection sensitivity, as a result of the individual parameter settings, especially through specifying different response sensibilities for the receivers, as well as an evaluation that is adapted thereto.

According to an embodiment of the present invention, the number and size of the sub-regions can be varied.

The sub-regions may furthermore be adapted to different application conditions with respect to number and size.

The adaptation of the sub-regions and the setting of parameters, as well as the evaluation mode may be specified during a configuration process before the start of the light curtain operation. This allows the user a simple and quick adjustment of the light curtain and its adaptation to different applications.

According to an embodiment of the present invention, separate object detection signals are generated in the evaluation unit for the individual sub-regions.

The individual sub-regions may form completely independent light curtain units in which separate object detections take place and, depending thereon, separate object reports are issued. The object detection signals can be the same or different for the individual sub-regions. The object detection signal for one or several sub-regions can thus be a binary switching signal which only indicates the presence of an object in the respective region. The object detection signal can furthermore also supply additional information such as the size and position of the object. A flexible multi-region monitoring is thus possible with the light curtain embodied in this way.

According to an embodiment of the present invention, the results obtained in the evaluation unit for individual sub-regions can be combined into a complex final result.

A super-imposed logic unit is thus provided, meaning an additional evaluation plane, in which the individual evaluation results for the individual sub-regions can be combined into higher-order information, especially for the detection of complex actions and structures. This additional function may be made available without additional structural expenditure since the evaluation unit, which is used for evaluating the signals from the individual sub-regions, may also be used for realizing these higher-order evaluations.

According to an embodiment of the present invention, results determined in the evaluation unit for the individual sub-regions are linked logically to form complex final results.

For example, individual objects detected in the different sub-regions can be linked via AND, respectively OR linkages, for which an exemplary embodiment is the control of objects being conveyed on a multi-belt conveyor.

According to that embodiment of the present invention, a light curtain sub-region may be defined for each belt and one requirement can be that an object is conveyed parallel on each belt. To check this, the individual object detections in the sub-regions can be recorded with an AND link in the evaluation unit.

According to an embodiment of the present invention, the results determined in the evaluation unit for the individual sub-regions are linked through arithmetic operations.

The counting of objects may furthermore be realized with arithmetic operations. If objects are conveyed parallel on a multi-belt conveyor, for example, a light curtain region can be defined for each belt, wherein the objects detected in the individual sub-regions are then counted parallel in the evaluation unit. Alternatively, the sizes or widths of the objects detected in the individual sub-regions can also be added up.

According to an embodiment of the present invention, the results determined for individual sub-regions are linked time-dependent in the evaluation unit.

A time-dependent tracking is possible with this type of embodiment, for example, wherein it is possible in particular to check whether objects move along defined paths.

According to an embodiment of the present invention, the evaluations of some sub-regions depend on the results of evaluations of other sub-regions.

This embodiment permits an automatic adaptation of the light curtain to specific edge conditions, meaning an automatic optimizing of the light curtain operation is achieved.

For example, through a suitable adaptation of the evaluation in dependence on the measuring results obtained for one or several sub-regions, the reaction sensitivities of receivers in defined sub-regions can be adjusted automatically in such a way that objects to be expected in these sub-regions can be detected with high detection certainty.

A further embodiment of the present invention relates to the automatic adaptation of the light curtain evaluation during the time-dependent tracking of objects. One example thereof is the tracking of an object path for which it is necessary that an object detected in a sub-region must have left this sub-region at the completion of a specified time period.

The evaluation realized in the evaluation unit then takes the form of a timer being started in the respective region as a reaction to the object detection. The evaluation in the sub-region is thus changed, such that an alarm is generated once the timer indicates that the specified time period has been exceeded during the registration of the object in the sub-region.

According to an embodiment of the present invention, a light curtain may comprise a transmitting unit with transmitters that emit light rays, wherein this unit is mounted at one edge of the monitored region. The light curtain may furthermore comprise a receiving unit with receivers for receiving the light rays, wherein this receiving unit is mounted on a second edge of the monitored region, opposite the first edge. Respectively one transmitter and an opposite-arranged receiver form a transmitter/receiver pair.

The individual transmitter/receiver pairs thus form individual light barriers for which the light rays define the light axes used to for scanning a monitored region within which an object can be detected.

Each sub-region may comprise a number of successively arranged transmitter/receiver pairs.

### BRIEF DESCRIPTION OF THE DRAWINGS

These and other features and advantages of the invention will be further understood from the following detailed description of embodiments with reference to the accompanying drawings in which:

FIG. 1 represents a schematic drawing of an exemplary embodiment of a light curtain according to the invention;

FIG. 2 shows an exemplary embodiment of the light curtain according to FIG. 1.

### DETAILED DESCRIPTION

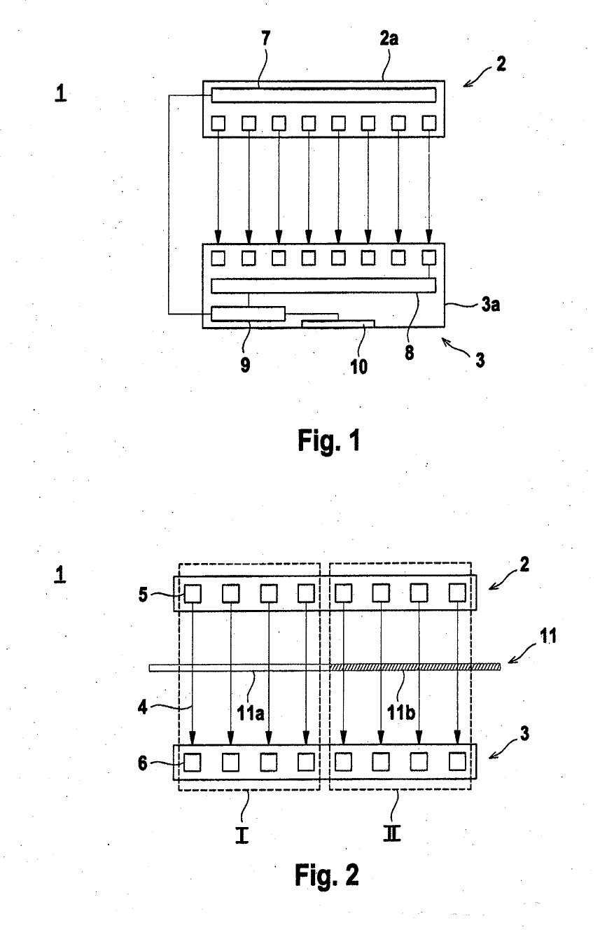

FIG. 1 shows an exemplary embodiment of the light curtain 1 according to an embodiment of the present invention. The light curtain 1 comprises a transmitting unit 2 with a first casing 2a and a receiving unit 3 with a second casing 3a. The transmitting unit 2 and the receiving unit 3 are positioned at opposite edges of a monitored region, within which objects are detected with the light curtain 1.

Positioned inside the casing 2a for the transmitting unit 2 is a linear arrangement of transmitters 5 for emitting light rays 4. The casing 3a for the receiving unit 3 comprises a linear arrangement of receivers 6 for receiving light rays 4, wherein the number of receivers corresponds to the number of transmitters 5. The transmitters 5 may be light-emitting diodes, laser diodes or the like. The receivers 6 may be photodiodes. A beam-forming transmitting optic which is not shown herein may be arranged downstream of the transmitters 5. A receiving optic for focusing the light rays 4 onto the receivers 6 may be arranged upstream of the receivers.

A receiver 6 is arranged opposite each transmitter 5, as can be seen in FIG. 1, such that with a clear monitoring region, the light rays 4 emitted by a transmitter 5 impinge on the associated receiver 6. The transmitter 5 and the receiver 6 thus form a transmitter/receiver pair which forms a so-called beam axis for the light curtain 1, wherein eight such beam axes are provided in the present embodiment. The number of beam axes for a light curtain 1 can vary. Also possible are arrangements for which the light rays 4 of a transmitter 5 may impinge on several receivers 6.

A first control unit 7 for controlling and activating the transmitters 5 may be located in the transmitting unit 2. A second control unit 8 for controlling and activating the receivers 6 may be located in the receiving unit 3. For the present embodiment, the control units 7, 8 are shift register arrangements which are controlled neutrally by a computer unit 9 in the receiving unit 3. This computer unit 9 may simultaneously function as an evaluation unit in which the signals present at the outputs of the receivers 6 are evaluated for the object detection. With the evaluation unit, the outputs of an output circuit 10 may be triggered to output evaluation signaled generated from the receiving signals.

With the computer unit 9 and the control units 7, 8, the individual transmitter/receiver pairs are activated cyclically and successively, meaning all transmitter/receiver pairs are activated once during a measuring cycle.

With the help of a configuration process prior to starting the operation of the light curtain 1, the transmitter/receiver pairs may be divided into different sub-regions, wherein it is possible to variably specify the size and number of the sub-regions. In general, the sub-regions can also be embodied so as to overlap. FIG. 2 shows a division of the transmitter/receiver pairs into two equally large sub-regions I and II, wherein the first sub-region I comprises the first four transmitter/receiver pairs and the second sub-region II comprises the last four transmitter/receiver pairs.

During the configuration process, different parameter sets and, in particular, different evaluation methods may be specified for the individual sub-regions.

The object detection in the monitored region may be generally realized in the evaluation unit with the aid of an amplitude evaluation, in particular a threshold evaluation of the signals present at the receiver 6. During the configuration process, the threshold values can be specified as parameters, with respect to height and number, so that the detection sensitivities may be specified separately for the individual sub-regions.

Additionally, specified parameters may be, for example, the minimum size for the objects to be detected, as well as time-dependent variables such as desired time periods during which objects are to be detected. Furthermore specified can be desired contours of objects which must be detected in individual sub-regions.

Furthermore specified can be the type of signal evaluation for each sub-region, wherein the output signals that are generated during the object detection, in particular, can be specified for the individual sub-regions. Finally, specific linkages of output signals for the individual regions can also be specified during the configuration process, so that complex final results can be generated therewith.

With the exemplary embodiment according to FIG. 2, the light curtain 1 may be oriented in a vertical plane. A film 11 that is positioned in a horizontal plane is moved through the region monitored by the light curtain 1. The film 11 is composed of two different transparent partial sections 11a and 11b. Both partial sections 11a and 11b contain holes which are detected with the light curtain 1. The light rays 4 which pass through these holes are weakened less than the light rays 4 that impinge on the film 11. As a result of the threshold evaluation of the signals received at the receiver 6, the holes can therefore be differentiated from the film material and can be detected.

The first partial section 11a of the film 11 is detected with the transmitter/receiver pairs of the first sub-region I of the light curtain 1. The second partial section 11b of the film 11 is detected with the transmitter/receiver pairs in the second sub-region II of the light curtain 1. For the detection of holes and because the partial sections 11a, 11b have a different light permeability, different threshold values must be specified for the evaluation of the signals received at the receivers 6 for both sub-regions I and II during the configuration process. The evaluation may furthermore be defined during the configuration process in such a way that a separate object detection signal is generated for each sub-region I, II. In the process, an object detection message is output for each sub-region I, II in the form of an object detection signal if holes are detected therein.

A super-imposed or higher order evaluation may furthermore be defined during the configuration process, so that the object detection signals for both sub-regions I, II are linked. This linking can be an AND linkage, for example, if it is required that always two holes must be detected simultaneously in both sub-regions I, II. Alternatively, the linking can also be a counting function for which the holes detected in the two sub-regions I, II are counted.

It will be understood that the above description of the present invention is susceptible to various modifications, changes and adaptations, and the same are intended to be comprehended within the meaning and range of equivalents of the appended claims.

We claim:

1. A light curtain for detecting objects within a monitored region, comprising:
an arrangement of transmitters for emitting light rays,
an arrangement of receivers for receiving the light rays, and
an evaluation unit configured to generate object detection signals in dependence on signals present at outputs of the receivers,
the light curtain having a plurality of sub-regions, each sub-region having a predetermined number of transmitters and receivers,
wherein each sub-region can be adjusted individually through separate parameter settings, and
wherein the evaluation unit is further configured to separately evaluate each sub-region.

2. The light curtain of claim 1, wherein the evaluation unit is further configured to generate separate object detection signals for each sub-region.

3. The light curtain of claim 1, wherein the evaluation unit is further configured to link separate results from each sub-region to form complex final results.

4. The light curtain of claim 3, wherein the evaluation unit is further configured to logically link the separate results from each sub-region to form complex final results.

5. The light curtain of claim 3, wherein the evaluation unit is further configured to link the separate results from each sub-region via arithmetic operations.

6. The light curtain of claim 3, wherein the evaluation unit is further configured to link time-dependent the separate results from each sub-region.

7. The light curtain of claim 1, wherein the evaluations for sub-regions are dependent on results of evaluations of other regions.

8. The light curtain of claim 1, further comprising:
a transmitting unit having transmitters for emitting light rays, the transmitting unit provided on a first edge of the monitored region;
a receiving unit having receivers for receiving light rays, the receiving unit provided on a second edge of the monitored region;
wherein the first edge of the monitored region is arranged opposite the second edge of the monitored region,
wherein one transmitter and an oppositely arranged receiver form a transmitter/receiver pair.

9. The light curtain of claim 8, wherein each sub-region comprises a number of successively following transmitter/receiver pairs.

10. The light curtain of claim 1, wherein the number and dimensions for the sub-regions can be varied.

11. A method for detecting an object within a monitored region with a light curtain, the light curtain having an arrangement of transmitters, an arrangement of receivers, and an evaluation unit, the method comprising:
emitting light rays from the arrangement of transmitters,
receiving the light rays with the arrangement of receivers,
generating object detection signals in the evaluation unit in dependence on signals present at the outputs of the receivers
dividing the light curtain into sub-regions with respectively a predetermined number of transmitters and receivers,
adjusting the sub-regions individually through separate parameter settings, and
realizing a separate evaluation in the evaluation unit for each sub-region.

12. The method of claim 11, further comprising generating separate object detection signals in the evaluation unit for the individual sub-regions.

13. The method of claim 11, further comprising linking results obtained for each sub-region in the evaluation unit to form complex final results.

14. The method of claim 13, further comprising logically linking results determined for each sub-region in the evaluation unit to form complex final results.

15. The method of claim 13, including linking the results determined in the evaluation unit for the individual sub-regions via arithmetic operations.

16. The method of claim 13, wherein the results determined in the evaluation unit for the individual sub-regions are linked time-dependent.

17. The method of claim 10, wherein the evaluations for sub-regions are dependent on results of evaluations of other sub-regions.

18. The method of claim 10, further comprising
providing the light curtain on a first edge of the monitored region with a transmitting unit with transmitter for emitting light rays, and
providing on a second edge of the monitored region, which is arranged opposite the first edge, an arrangement of receivers that receive the light rays,
wherein respectively one transmitter and an opposite arranged receiver form a transmitter/receiver pair.

19. The method of claim 18, wherein each sub-region comprises a number of successively following transmitter/receiver pairs.

20. The method of claim 10, wherein the number and dimensions for the sub-regions can be varied.
